(19) United States
(12) Patent Application Publication
(10) Pub. No.: US 2007/0124803 A1
(43) Pub. Date: May 31, 2007

(54) Method and apparatus for rating a compliance level of a computer connecting to a network

(75) Inventor: Ramin Taraz, Lexington, MA (US)

Correspondence Address: JOHN C. GORECKI, ESQ., P.O BOX 553, CARLISLE, MA, 01741, US

(73) Assignee: Nortel Networks Limited, St. Laurent (CA)

(21) Appl. No.: 11/289,740

(22) Filed: Nov. 29, 2005

(51) Int. Cl. H04L 9/00; H04L 9/32; G06F 11/00; G06F 17/00; G06K 9/00; G06F 12/14; H04K 1/00; G06F 17/30; G06F 15/16; G06F 12/16; G06F 7/04; G06F 15/18; G06F 7/58; G08B 23/00; G06K 19/00

(52) U.S. Cl. 726/4; 726/1; 726/25; 726/5; 726/6; 726/7

(57) ABSTRACT

Rules are used to determine a compliance level for a computing device attempting to access a network. The compliance level may have multiple categories or facets, that may be determined individually or collectively, to determine a score for the computing device. The score may be used to determine whether the computing device should obtain access to the network, the type of access to be granted, or whether remediation should occur and what type of remediation should occur on the computing device to enable the computing device to enjoy greater network privileges. Optionally, the score may be weighted in connection with the user privileges associated with the user as determined during the authentication process, to enable users with greater network access privileges to access the network in situations where other users may not be able to access the network.

### BACKGROUND OF THE INVENTION

1. Field of the Invention

The present invention relates to communication networks and, more particularly, to a method and apparatus for rating a compliance level of a computer connecting to a network.

2. Description of the Related Art

When a computer connects to a communication network such as a local area network associated with an enterprise, the computer may expose the network to various types of malicious code that may be located on the computer. For example, a computer unknowingly or intentionally may contain viruses, malware, Trojan horses, keystroke-logging software, spyware, and many other types of malicious code designed to impair operation of the computer or network or to spy on the computer or network. Code of this type is commonly installed without the user's knowledge, for example during ordinary on-line transactions on the Internet. Code of this nature may also be installed intentionally, for example where the user would like to attempt to cause the malicious code to be installed on a network or computer for illicit gain.

One way to control malicious code is to require anti-virus and anti-spyware software packages to be run on the personal computers. Since new threatening software is developed and new threats are identified almost daily, it is important to update the files on the computer to ensure that the computer is protected against the latest threats. Having up-to-date antivirus and anti-spyware files provides a reasonable amount of protection against malicious code, but may not provide complete protection.

Often an authorized network user, such as an employee of a corporation, may want to obtain access to a network to enable the user to perform various functions available via the network, such as checking e-mail, participating in on-line meetings, accessing documents, and otherwise working on the network. To do so, the user may connect a computer to the network via an Ethernet port, may cause a connected computer to boot and thus initiate a connection to the network, or may cause the computer to initiate a connection to the network from a remote location.

To protect the network and other computers on the network against unwanted exposure to malicious code that may be present on the connecting computer, it has become commonplace for a compliance check to be performed as part of the connection process, in addition to standard authentication and authorization procedures. A compliance check enables the network to determine if the connecting computer has the proper software configuration to enable the network administrator to be reasonably sure that it is safe for the computer to connect to the network. For example, the compliance check may determine whether the computer is running anti-virus software, firewall software, and other types of software, whether these processes are currently active, and whether the files being used by these processes are up-to-date. Similarly, the compliance check may determine whether the computer has particular files, such as security patches, downloaded and installed. The compliance check may also check to see if any known threats are active on the computer.

There are several consortiums looking into ways in which security may be implemented in connection with providing computers with access to the network. For example, a group of vendors have formed the Trusted Computing Group (TCG), which was designed to create open specifications for network security. The specifications are intended to be platform, device, and vendor agnostic and intended to establish a security framework designed to prevent unmanaged devices from connecting to a network. As another example, Cisco Systems™ has been involved with an effort referred to as Network Admission Control (NAC), which is designed to ensure that endpoint devices accessing a network are adequately protected from threats such as viruses, worms, and spyware. Similarly, Microsoft™ has been involved in an effort that is referred to as Network Access Protection (NAP), which is integrated into the Microsoft™ Windows™ operating system. The platform enforces system requirements defined in policies that must be met by devices connecting to the network. Devices that don't comply with the policies are limited to specific areas of the corporate network until they can be updated.

The solutions proposed to date enable a compliance server or other network device to make a yes/no determination as to whether a computer should be provided with access to the network. If the computer does not pass the compliance check, the computer will not be allowed to connect to the network and optionally may be directed to an area where remediation may occur to bring the computer into compliance. While this result may be sufficient in particular circumstances, in other circumstances it may be preferable to have more information associated with the compliance level of a particular computer.

### SUMMARY OF THE INVENTION

The present invention overcomes these and other drawbacks by providing a method and apparatus for rating a compliance level of a computer connecting to a network. According to an embodiment of the invention, to enable greater intelligence to be used in connection with granting network access, a method of performing a compliance check on a computer in a more granular fashion is provided, and the result of the compliance check may be used to balance the amount of compliance against the intent of the network access to enable more intelligent decision making in connection with network admission control processes.

According to an embodiment of the invention, rules are used to determine a compliance level for a computing device attempting to access a network. The compliance level may have multiple categories or facets, that may be determined individually or collectively, to determine a score for the computing device. The score may be used to determine whether the computing device should obtain access to the network, the type of access to be granted, or whether remediation should occur and what type of remediation should occur on the computing device to enable the computing device to enjoy greater network privileges. Optionally, the score may be weighted in connection with the user privileges associated with the user as determined during the authentication/authorization process, to enable users with greater network access privileges to access the network in situations where other users may not be able to access the network.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a functional block diagram illustrating a network environment in which a computer may connect to a communication network;

FIGS. 2 and 3 are a flow charts illustrating processes that may be used to determine a type of network access to be provided depending on the compliance level of a computer connecting to the network according to embodiments of the invention; and

FIG. 4 is a functional block diagram of a compliance server according to an embodiment of the invention.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

According to an embodiment of the invention, rules are used to determine a compliance level for a computing device attempting to access a network. The compliance level may have multiple categories or facets, that may be determined individually or collectively, to determine a score for the computing device. The score may be used to determine whether the computing device should obtain access to the network, the type of access to be granted, or whether remediation should occur and what type of remediation should occur on the computing device to enable the computing device to enjoy greater network privileges. Optionally, the score may be weighted in connection with the user privileges associated with the user as determined during the authentication process, to enable users with greater network access privileges to access the network in situations where other users may not be able to access the network.

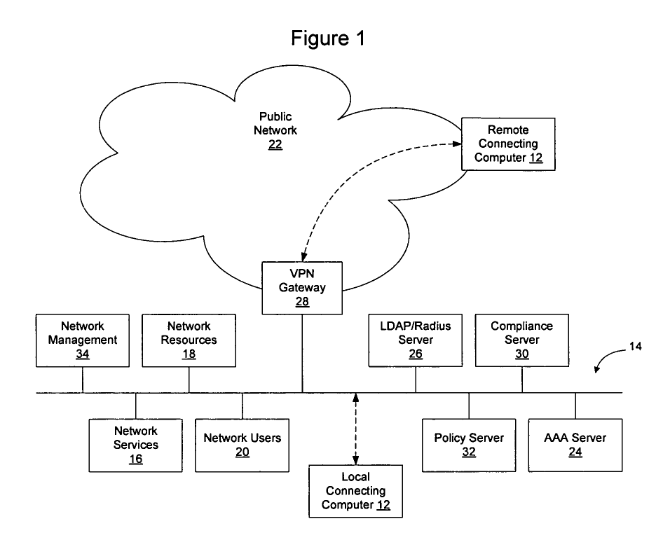

FIG. 1 illustrates an example in which a computer 12 may attempt to connect to a network 14 to obtain access to network services 16, network resources 18, and other network users 20 commonly accessible on the network 14. The computer may attempt to connect to the network locally via an Ethernet or other directly connected network port, or may attempt to connect to the network from a remote location, for example over a public network 22.

When the computer 12 attempts to connect to the network, the user associated with the computer will need to present credentials sufficient to enable the network to authenticate the user's identity, and determine the user's authorization to access the network. To facilitate these functions, the network 14 may include an Authentication, Authorization, and Accounting (AAA) server 24. The AAA server may operate in a number of different ways, depending on the level of security to be implemented. There are many different ways of authenticating users and determining authorization levels for the users and the invention is not limited to implementation of any particular method.

The AAA server 24 may operate in tandem with a Light-Weight Directory Access Protocol (LDAP)/Remote Dial-In User Access Server (RADIUS) server 26 configured to facilitate remote access to the network. For example, in the example shown in FIG. 1, a remote connecting computer 12 is attempting to access the network 14 over a public network 22. The LDAP/RADIUS server 26 may be used to facilitate this process to determine if the user has been authenticated, and whether the user is authorized to access the network in the manner provided. Optionally, once the user has been granted access, a Virtual Private Network (VPN) tunnel may be established, e.g. between the remote connecting computer 12 and a VPN gateway 28, to secure communications between the computer and the network. The invention is not limited to the particular manner in which remote computers are provided with access or to how communications with the remote computers is protected on the public network.

As mentioned above, when a computer is to connect to a network, it may be desirable to determine if the computer is properly configured, whether any required processes are running that may be used to prevent malicious code from being activated on the computer, and to ensure any other configuration parameters have been met. According to an embodiment of the invention, a compliance server 30 attached to the network or made available to the network e.g. via a VPN tunnel over the public network, may be used to rate the compliance of the connecting computer. Several examples of how the compliance server may be configured to operate and several rating schemes will be provided in greater detail below.

As shown in FIG. 1, the network also may include a policy server 32 accessible by a network administrator, e.g. via network management terminal 34, to set policies on the network. The policies may contain configuration information such as computer configuration definitions to be used by the compliance server, and may also contain policies designed to allow the compliance server to rate partial compliance with a particular configuration definition so that the compliance server may generate a compliance score associated with the connecting computer. Although the embodiment illustrated in FIG. 1 shows a separate policy server and compliance server, the invention is not limited in this manner as optionally the compliance server and policy server may be implemented as a single process/server.

The network administrator may set many different types of policies that may be used to check the configuration of a computer attempting to connect to the network. For example, the network administrator may specify policies regarding the type of network access to be provided to users according to their network access level and/or compliance level. Additionally, the network administrator may specify different policies regarding the type of access to be provided depending on the intended action(s) to be performed by the computer on the network. The policies may also specify the particular software and/or hardware configurations that are acceptable, which are not, and may specify how compliance should be rated when a computer exhibits partial compliance to a specified configuration. Many different types of policies may be implemented and the invention is not limited to an implementation that uses a particular type of policy. Rather, embodiments of the invention use the policies to rate the compliance level of connecting computers to provide more information about the connecting computer than simply a yes/no indication as to whether the computer is deemed compliant. By providing a compliance score, it is possible to make a more intelligent decision as to the type of network access to be provided and the extent of and urgency of remedial action to be provided to the user/computer to bring the computer into greater compliance.

The compliance server takes the policies specified by the network administrator, obtains information associated with the configuration of the computer attempting to access the network, and rates the computer according to its compliance level. As a result of this process, the compliance server will create a compliance score for the computer, which may indicate a compliance level in one or more than one category. For example, the compliance server may generate a compliance score for antivirus software, unknown or malicious processes, user-configurable preferences, required code, and other processes.

A gateway or other policy implementation point may be used to enforce the policy driven decision derived from the compliance server. Alternatively, the policy server may be used to determine a level of network access based on a compliance score provided by the compliance server. Many different combinations of actions may be taken other than providing a yes/no decision as to whether the connecting computing device has a compliant profile so that differentiated network access may be provided to users with different compliance levels.

The compliance server may generate a compliance score in connection with rating a computer connecting to the network. The compliance score may be a composite compliance score having multiple facets, or may be a pure compliance score designed to provide an overall compliance ranking of a particular computer. Where the compliance score is a composite compliance score, the policy server may control the compliance server to dictate the facets to be measured, how measurement of each of the facets should be performed, and how different categories within each facet should be weighted. By obtaining a score from the compliance server, indicating the compliance level of the computing device in one or more categories, it is possible to determine in a more granular fashion which computing devices should be allowed access to the network and what type of access they should be provided. Additionally, by categorizing the compliance level to provide compliance values in two or more categories, more intelligent access decisions may be made to provide greater network access stratification.

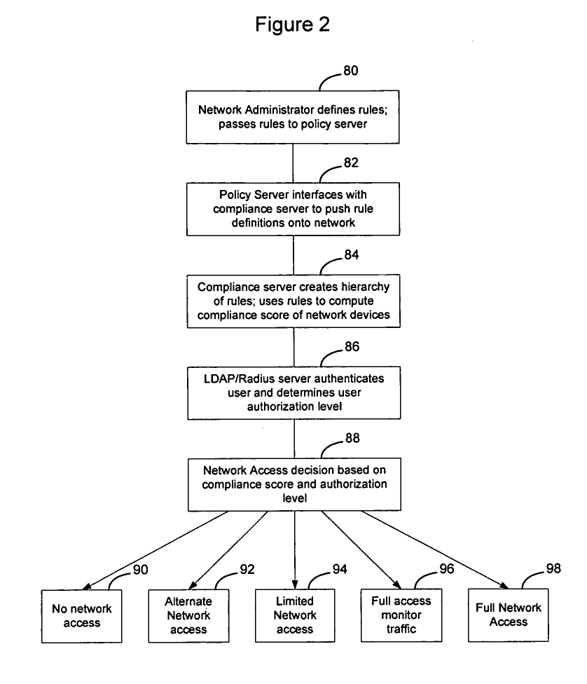

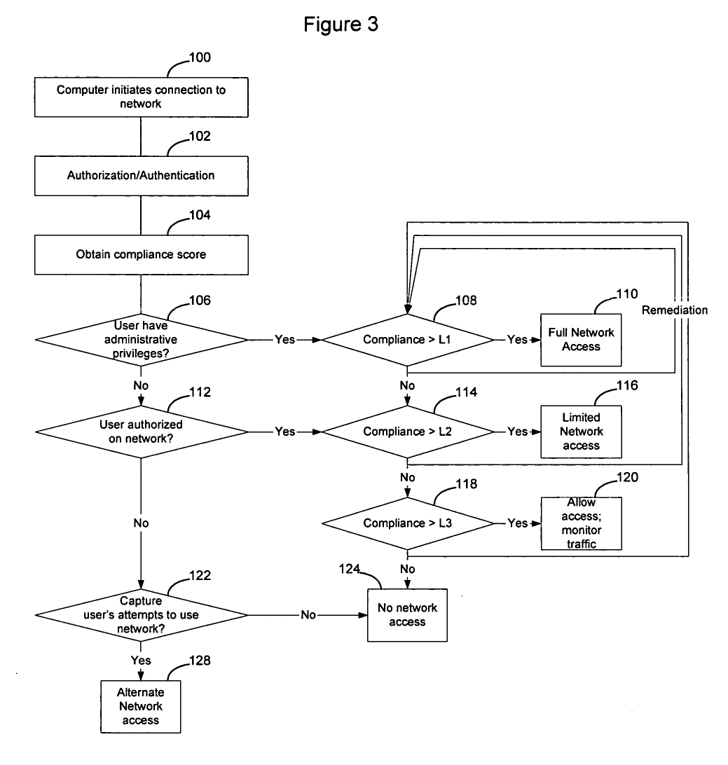

FIG. 2 illustrates a process of determining, by a network, what type of network access should be granted to a computer connecting to the network. As shown in FIG. 3, the network administrator defines rules, and passes the rules to the policy server (80). The policy server interfaces with the compliance server to push the rule definitions onto the network (82). The compliance server creates an hierarchy of rules, and uses the rules to compute a compliance level of an attaching device in one or more categories and passes the value back to the policy server (84). An LDAP/RADIUS server, alone or in connection with an AAA server, authenticates a user associated with the computer and determines an authorization level of the user (86).

Once a compliance score and authorization level have been determined, a network access decision is made for the computer, based on the compliance score and authorization level (88). The policy server may base the network access decision on the score by determining whether the attaching device meets or exceeds the minimum standard level for one or more of the categories that were used to generate the compliance score. The result of this comparison will govern whether the user is granted no network access, alternate network access, limited network access, network access with traffic monitoring, full/unrestricted network access, or another level of network access.

Many different types of network access may be granted, and many ways of enforcing the different types of network access may be used. As shown in FIG. 2, a connecting computer may be provided with no network access (90) in which the computer is completely denied access to the network. This may occur where it is clear that the computer contains a malicious virus that is not able to be cleansed through remedial action and where providing any network access may place the network at risk of contacting the virus.

A connecting computer may also be provided with alternate network access (92). Alternate network access may occur by causing the connecting computer to be connected to a network other than the main network. This may be done to enable the actions of the user to be monitored without the user's knowledge to see if the user is attempting to interact maliciously with the network. Alternate network access may also be provided where remedial action is to be taken on the computer before the computer is allowed to connect to the main network 14. For example, a computer may need to have malicious processes removed from its system and may require updated antivirus files to be downloaded and installed before it is allowed to connect to the main network. Alternatively, the computer may need to have updated system files installed to enable the computer to interact with the other computers on the network. Thus, alternate network access may be provided where the computer needs to be updated before joining the network. Other reasons for providing alternate network access may be conceived as well and the invention is not limited to these several specific examples.

As shown in FIG. 2, a computer may be provided with limited network access (94). This is the type of network access provided to most users. Many networks have restricted areas that only particular users are allowed to access. For example, in a corporation, there may be an area on the network that only Human Resources personnel may access, and a different private area that only corporate legal personnel may access. Thus, when a user access the network, generally the user's ability to operate within the network will be limited in particular ways. Accordingly, where a computer is compliant, the authorization level of the user may dictate that limited network access be provided to the user (94). Similarly, a network administrator may not have any restrictions on where they can go on the network, and accordingly full network access may be provided to those users with a higher authorization level (98).

Limited or Full access may also be provided with traffic monitoring (96), where the compliance check indicates that a particular computer is more likely than other computers to be operating in an undesirable manner on the network. For example, where the compliance check indicates that the score in a firewall area is low for a particular computer, it may be more likely for a hacker to try to gain access to the computer network by going through that less compliant computer. To prevent this from occurring, the traffic may be monitored and optionally passed through a network firewall to provide proxy firewall services on behalf of the computer. Other reasons for monitoring traffic may exist as well and the invention is not limited to this particular example.

The network administrator may set levels for each of the categories to be evaluated by the compliance server. The levels may be individually adjusted for each category so that devices attaching to the network may be required to be more compliant in one category than in other categories. The levels for each category may be set at different values, or thresholds, depending on the user authorization level as well to enable the network administrator to require different types of users to be compliant in different ways in order to obtain particular types of network access. Additionally, the levels may be varied depending on the user group so that different groups of users may be required to be more compliant than other groups of users.

For example, assume that the network administrator would like to check each attaching network device for compliance in categories including (1) anti-virus protection; (2) anti-spyware protection; (3) presence or absence of identified undesirable processes or threads; (4) personal firewall protection; (5) up-to-date antivirus and anti-spyware files; (6) user-defined settings in conflict with network-defined settings. The network administrator may feel strongly that every user should have up-to-date antivirus and anti-spyware files, since those files are relatively easy to update. Thus, relatively high compliance value may be required for access to the network in this category. However, not every computer may be running a personal firewall and the network may provide firewall services on behalf of the user if alerted to the lack of a personal firewall. Thus, the particular scores in different areas may enable the network to provide different services to the computers in addition to determining the level of access to be provided to a particular connecting computer.

The levels may be varied depending on the type of action to be taken on the network. For example, when a computer is being used to log on to a network for an user with administrator privileges, the network management may require that the computer have high compliance in all compliance areas, since the network administrator is likely to have access and the ability to perform particular actions on the network that would be blocked for other users. Alternatively, the network administrator may feel that network administrator should be allowed to log on with whatever network device they want, since they are in charge of the network. Thus, the thresholds for a user with network administrator privilege level may, alternatively, be set relatively low. Thus, the particular levels may be varied depending on the authorization level of the user to provide further intelligence in connection with performing compliance checks as computers connect to the network.

Additionally, different classes of authorization may need to comply with different criteria not applicable to other classes of users. For example, a network administrator may be required to have a particular software profile on their computer that is not made available to other network users. In this example, the compliance server may be configured to check for the presence of a particular cookie or a process with a particular signature to be extant and operating on the computer before full network access is provided to the network administrator. In this way, an additional layer of security may be enforced in connection with particular classes of users to guarantee that the users are accessing the network in an intended fashion only with particular computers determined to be acceptable to access the network in a particular manner.

FIG. 3 is a flow chart illustrating an example of a process that may be used to determine a type of network access to be provided depending on the compliance level of a computer connecting to the network according to embodiments of the invention. The invention is not limited to this particular process as many similar processes may also be used. As shown in FIG. 3, when a computer initiates a connection to the network (100) the user will be authenticated to the network and an authorization indication will be obtained with respect to the user (102). Additionally, the computer will be evaluated, as discussed above, to obtain a compliance score for the computer (104).

If the user has administrative privileges (106) the compliance score will be checked against a first compliance matrix L1 (108) to determine if the computer has achieved sufficient compliance in the categories defined by the first compliance matrix. If it has, full network access or another network access level appropriate for the administrator will be provided (110). Optionally, the administrative check (106-110) may be omitted and the invention is not limited to an embodiment that includes a determination as to whether the user has administrative privileges.

If the computer has not achieved compliance sufficient to satisfy the first compliance matrix L1, the computer compliance may be checked against a second compliance matrix L2 (114), a third compliance matrix L3 (118), and against other compliance matrixes to determine what type of network access should be provided to the user. For example, if the computer's compliance score satisfies the second compliance matrix L2, limited network access may be provided (116) whereas if the computer's compliance score satisfies the third compliance matrix access may be provided with traffic monitoring (120). Remediation may be provided at any step to help bring the computer compliance score into compliance with higher level compliance matrixes.

If the user does not have administrator privileges, it will be determined if the user is authorized on the network. (112). If the user is an authorized user, the computer compliance score will be checked against one or more of the compliance matrixes to determine the particular type of network access to be provided to the computer. Since only administrators are provided with full network access, in this embodiment, the computer is not allowed to be checked against the compliance matrix L1, however.

If the user is determined to not be authorized to access the network, a decision may be made to try to attempt to capture the user's attempts to use the network (122). Capturing the user's actions in attempting to obtain unauthorized access to a network may enable the network administrator to learn the identity of the user or otherwise enable the network administrator to increase the security features of the network. If a decision is made to record the user's attempt to access the network, the user may be provided with alternate network access (126) in which it appears to the user that they have been provided with network access when in reality they have not been provided with network access. Otherwise, network access may be denied to the user (124).

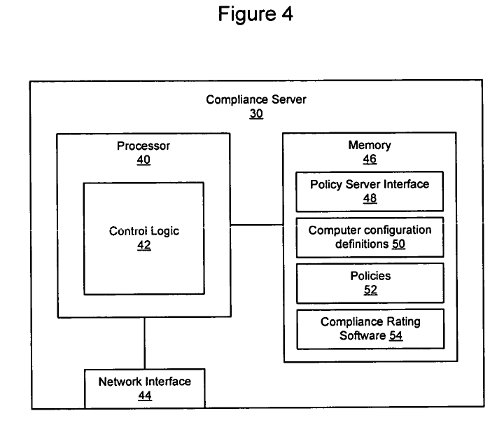

FIG. 4 is a functional block diagram of a compliance server configured to implement an embodiment of the invention. As shown in FIG. 4, the compliance server 30 generally includes a processor 40 containing control logic 42 configured to perform functions described to enable the compliance server to generate compliance scores associated with computers connecting to a network as described above in connection with FIGS. 1-3.

The compliance server may be provided with one or more components (hardware and/or software) to enable it to communicate on a communication network. For example, in the illustrated embodiment, the compliance server 30 includes a network interface 44 configured to enable the compliance server to communicate on the network 14 or public network 22. The network interface may be an Ethernet interface or may be configured using another technology. The invention is not limited by the particular type of technology used to implement the network interface. Where the compliance server is to provide compliance services to multiple networks, the compliance server may be implemented on the network and connected to the networks requiring compliance services using VPN tunnels. The invention is thus not limited to an embodiment in which the compliance server is implemented on a particular local area network but rather extends to other embodiments in which the compliance service is located external to the local area network to be serviced.

The compliance server may include a computer readable memory 46 configured to store data and instructions to enable the control logic 42 to be configured to implement the functions described above and attributable to the compliance server. For example, the memory may contain a software module configured to implement a policy server interface 48 configured to enable the compliance server 30 to interface with the policy server to obtain computer configuration definitions 50 and other policies 52 that will enable the compliance server to generate a compliance score in a manner specified by a network manager. The memory 46 may also include compliance rating software 54 configured to use the computer configuration definitions 50 and policies 52, connecting computer configuration information, and generate a compliance score for the computer. Other modules may be included as well and the invention is not limited to the particular implementation described herein in connection with FIG. 4.

The functions described above may be implemented as a set of program instructions that are stored in a computer readable memory within the network element and executed on one or more processors within the network element. However, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, a state machine, or any other device including any combination thereof. Programmable logic can be fixed temporarily or permanently in a tangible medium such as a read-only memory chip, a computer memory, a disk, or other storage medium. Programmable logic can also be fixed in a computer data signal embodied in a carrier wave, allowing the programmable logic to be transmitted over an interface such as a computer bus or communication network. All such embodiments are intended to fall within the scope of the present invention.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A method of rating a compliance level of a computer connecting to a network, the method comprising the steps of:
obtaining configuration information associated with the computer connecting to the network;
evaluating the configuration information in a plurality of categories to determine a compliance score for the computer, said compliance score indicating a level of compliance of the computer other than simply a pass/fail indication.

2. The method of claim 1, further comprising the step of:
granting network access at a network access level commensurate with the compliance score.

3. The method of claim 1, further comprising the step of:
using the compliance score to determine a type of network access to be provided to the computer connecting to the network.

4. The method of claim 3, wherein the type of network access is selected from a plurality of network access types.

5. The method of claim 4, wherein said network access types include no network access, alternate network access, limited network access, full network access with traffic monitoring, and full network access.

6. The method of claim 1, wherein the configuration information comprises a list of processes running on the computer and a list of programs loaded on the computer

7. The method of claim 1, further comprising the steps of:
obtaining user information for an user associated with the computer; and
using the user information in connection with evaluating the configuration information.

8. The method of claim 7, further comprising the step of evaluating the user information to ascertain an user authorization level.

9. The method of claim 8, wherein the type of network access to be provided depends on a combination of the compliance score and the user authorization level.

10. The method of claim 1, further comprising the step of:
receiving rule definitions to be used in connection with the step of evaluating the configuration information, said rule definitions being configured to be used to determine the compliance score.

11. The method of claim 1, wherein the compliance score is a composite score including multiple individual compliance levels, each of said individual compliance levels being indicative of an amount of compliance of the computer in one of a plurality of available categories as compared to an optimal configuration for that category.

12. The method of claim 11, wherein the categories include at least antivirus protection, firewall software, and the presence or absence of particular files.

13. The method of claim 12, wherein the categories further include the presence or absence of particular active processes, and whether files used by the processes are up-to-date.

14. A compliance server, comprising:
control logic configured to receive configuration information associated with a computer connecting to a network, and
control logic configured to compare the received configuration information with compliance definitions to determine a compliance score of the computer, said compliance score indicating a value of the compliance of the computer relative to fill compliance as defined by the compliance definitions.

15. The compliance server of claim 14, wherein the compliance definitions are grouped into compliance matrixes.

16. The compliance server of claim 15, wherein said compliance score indicates a value of the compliance of the computer in each of said compliance matrixes.

17. The compliance server of claim 14, further comprising control logic configured to receive user information for an user associated with the computer.

18. The compliance server of claim 17, further comprising control logic configured to threshold the compliance score to determine a network access level for the computer.
